(19) United States
(12) Patent Application Publication
(10) Pub. No.: US 2016/0270613 A1
(43) Pub. Date: Sep. 22, 2016

(54) CYCLONE SEPARATOR APPARATUS

(71) Applicant: Alfred Kärcher GmbH & Co. KG, Winnenden (DE)

(72) Inventors: Yunus Demirtas, Kornwestheim (DE); Werner Rentschler, Waiblingen (DE)

(21) Appl. No.: 15/166,567

(22) Filed: May 27, 2016

Related U.S. Application Data
(63) Continuation of application No. PCT/EP2013/075022, filed on Nov. 28, 2013.

(51) Int. Cl. A47L 9/16; A47L 7/00; B04C 9/00; B04C 5/185; B04C 5/081; B04C 5/04

(52) U.S. Cl. CPC A47L 9/1608; B04C 5/081; B04C 5/04; B04C 9/00; B04C 5/185; A47L 9/1683; A47L 7/0023; B04C 2009/004

(57) ABSTRACT

Cyclone separator apparatus for a cleaning device, including a swirl chamber having a shell wall which delimits a separator space; a dip tube extending into the separator space of the swirl chamber; a negative pressure application connection which is arranged at the dip tube or is operatively connected for fluid communication therewith and is connectable or connected to a suction unit; at least one intake opening which is arranged at the swirl chamber; and at least one discharge opening which is arranged at the swirl chamber, wherein the at least one discharge opening is configured in the form of a slot in the shell wall.

### CROSS-REFERENCE TO RELATED APPLICATIONS

This application is a continuation of international application number PCT/EP2013/075022 filed on Nov. 28, 2013, which is incorporated herein by reference in its entirety and for all purposes.

### BACKGROUND OF THE INVENTION

The invention relates to a cyclone separator apparatus for a cleaning device, comprising a swirl chamber having a shell wall which delimits a separator space, a dip tube extending into the separator space of the swirl chamber, a negative pressure application connection which is arranged at the dip tube or is operatively connected for fluid communication therewith and is connectable or connected to a suction unit, at least one intake opening which is arranged at the swirl chamber and at least one discharge opening which is arranged at the swirl chamber.

The invention further relates to a cleaning device.

WO 2012/123013 A1 discloses a cyclone separator for a suction cleaning device, wherein the cyclone separator comprises a separating container for separating suctioned cleaning liquid, including an inlet through which suction air and cleaning liquid are capable of being drawn into an interior space of the separating container, thereby creating a cyclone, a suction conduit extending into the interior space and being connectable to a suction unit, including an outlet through which suction air can be drawn out of the interior space, and a partition wall shielding the outlet from cleaning liquid, wherein an interspace exists between an inner wall of the separating container and the partition wall. The cyclone separator comprises at least one transfer element arranged between the partition wall and the inner wall for transferring cleaning liquid from the partition wall to the inner wall, said transfer element bridging the interspace between the partition wall and the inner wall except for a maximum remaining interspace of 2 mm.

### SUMMARY OF THE INVENTION

In accordance with an embodiment of the invention, a cyclone separator apparatus is provided that provides good separation performance while being of compact construction.

In accordance with an embodiment of the invention, the cyclone separator apparatus comprises at least one discharge opening which is configured in the form of a slot in the shell wall.

The suction unit generates a suction flow, and the separator space has a negative pressure applied thereto via the dip tube. Suction fluid can be drawn in via the suction flow generated. The suction fluid, which is dirt-laden fluid (dirt-laden air which may contain an amount of liquid) is coupled into the separator space via the at least one intake opening. A cyclonic flow develops in the swirl chamber, and vortex separation occurs. Separated medium is discharged via the at least one discharge opening.

The swirl chamber and hence the cyclone separator apparatus in its entirety can be configured in a compact form. Separated medium is discharged from the swirl chamber in an effective manner and does not remain therein.

By the arrangement of the at least one discharge opening in the form of a slot in the shell wall, a low inclination dependence of the cyclone separator apparatus can be realized.

The cyclone separator apparatus constructed in accordance with the invention can be advantageously used in conjunction with suction cleaning devices suitable for both dry suction cleaning (designed to handle dry dirty fluid) and wet suction cleaning (designed to handle wet dirty fluid). It can find use in spray extraction devices and wet vacuum cleaners for example. It may also be used for dry vacuum cleaners. It may for example be used in scrubber suction machines or also in sweeper suction machines. Also, it may be used in cleaning devices for use on smooth surfaces, such as glass surfaces.

By the fact that it is constructed in a compact form and that it demonstrates a certain independence of inclination, it may advantageously be used for hand-guided cleaning devices, such as hand devices or hand-carried cleaning devices.

In particular, the swirl chamber can have simple structure when it is configured with a cylindrical shell wall.

It is particularly advantageous for the at least one discharge opening to be oriented, in a direction of longitudinal extent, at least approximately parallel to the dip tube and/or at least approximately parallel to a generatrix of the shell wall and/or at least approximately parallel to an axial direction of the swirl chamber. This results in effective discharge of separated medium from the separator space. The need for separated medium to be stored within the separator space is eliminated so that the separation process will not be adversely affected.

In particular, the at least one discharge opening has a length in a direction of longitudinal extent and has a width in a direction transverse to the direction of longitudinal extent, wherein the width is less than the length. This results in effective discharge of separated medium.

It is advantageous for the width to be constant over the direction of longitudinal extent. Effective discharge of separated medium is thereby accomplished with simple structure.

It is further advantageous for the width to be no more than 40% of the length. This results in effective discharge of separated medium from the separator space.

Commonly occurring contaminants can be discharged in an effective manner when the width is at least 4 mm and is in particular at least 5 mm and/or is at most 25 mm and is in particular at most 20 mm.

It is particularly advantageous for the shell wall to have arranged thereat a single discharge opening which is in particular connected or continuous. This results in an effective discharge action.

It is particularly advantageous for the separator space to have an inside length in an axial direction and for the at least one discharge opening to extend over at least 90% of the inside length and in particular over at least 95% of the inside length and in particular over the full inside length. This provides a way of discharging separated medium over a wide range; as a result, effective discharge of separated medium can be effected.

It is advantageous for the separator space to have a constant cross-section along an axial direction. This provides a way of configuring the separator space with simple structure.

For the same reason, it is advantageous for the shell wall to be of cylindrical configuration.

Effective cyclonic flow within the separator space can be developed when the dip tube is of cylindrical configuration relative to an outer side thereof and/or an inner side thereof.

It is advantageous for an angle between the at least one intake opening and the at least one discharge opening to be in the range between 120° and 360° and to be in particular in the range between 150° and 360°, relative to a flow direction of fluid at the intake opening. Here, the flow direction reference holds for the angular direction.

In particular, in intended use, the at least one discharge opening is arranged below the at least one intake opening with respect to the direction of gravity and is in particular arranged in the area of a lowermost point of the swirl chamber with respect to the direction of gravity. This results in an effective discharge action.

Furthermore, it is advantageous if, in intended use of the cleaning device, an axial axis of the swirl chamber is oriented at least approximately horizontally with respect to the direction of gravity. This results in an effective discharge action. An orientation of the at least one discharge opening with respect to a vertical axis can be subject to fluctuations, i.e. the position of the at least one discharge opening can vary at least within a certain range, with respect to the vertical direction. The cyclone separator apparatus constructed in accordance with the invention can thereby be advantageously used on a hand-carried device.

It is advantageous for the at least one intake opening to be arranged at the swirl chamber such that flow entering thereinto develops in a path that is at least approximately parallel to a tangent to the shell wall. A cyclonic flow pattern can thereby be realized in an effective manner. It may also be provided for the at least one intake opening to be arranged at the swirl chamber in such a way that a spiral inflow pattern can be realized.

It is advantageous for the dip tube to be arranged at a first end wall of the swirl chamber which is oriented transversely to the shell wall and delimits the separator space. The dip tube can thereby be arranged in parallel to the shell wall.

A second end wall of the swirl chamber which is located opposite the first end wall and delimits the separator space is in particular configured in a manner that is free of openings. The swirl chamber can thereby be realized in a simple manner. In particular, the first end wall and the second end wall are parallel to each other and are, at least with respect to the delimitation of the separator space, the same cross-section and also the same shape.

Furthermore, it is advantageous for the at least one discharge opening to be oriented at least approximately parallel to a principal direction of flow of suction air inside the dip tube. This results in effective discharge of separated medium.

It is further advantageous for the dip tube and/or for a conduit leading from the dip tube to the suction unit to have a mechanical filter associated therewith. The mechanical filter is in particular a permanent filter and is for example configured as a fine filter. It serves to largely keep the dirt particles from entering the suction unit. In particular, the mechanical filter is positioned at the dip tube. With this arrangement, it can be positioned interiorly of the separator space or it can be positioned exteriorly of the separator space.

In an exemplary embodiment, a collar is arranged at a mouth of the dip tube in the separator space, said collar having an extent transverse to the dip tube and facing away from the dip tube. By the provision of such a collar, the ingress of liquid from the separator space into the dip tube can be prevented or at least reduced.

It is then advantageous for the collar to comprise one or more elements that project transversely from the dip tube and at least reduce liquid entry thereinto.

For the same reason, it is advantageous for the collar to have a larger maximum outer diameter than that of the mouth of the dip tube.

In an exemplary embodiment, the collar is configured as a frustoconical element. A “mouth enlargement” is thereby obtained which on the one hand interferes as little as possible with the suction flow for developing the cyclonic flow and on the other hand at least reduces the entry of liquid into the dip tube.

In a further exemplary embodiment, the collar has a raised rim, in particular wherein by way of the raised rim there is formed at the dip tube or on an extension of the dip tube a channel around the dip tube (or the extension of the dip tube). The raised rim prevents the ingress of liquid from the separator space into the dip tube.

It is further advantageous for the separator space to have arranged therein a guide device for the flow which predetermines a direction for the flow inside the separator space. This results in an effective discharge action.

Advantageously, the at least one discharge opening leads into a storage for separated medium. The discharge opening is, in a sense, the interface between the separator space of the swirl chamber and the storage. This provides a way for separated medium to be discharged directly, and the separation process in the swirl chamber is not adversely affected.

In an exemplary embodiment, the storage is a first storage which is located upstream of a second storage, wherein the second storage is operatively connected for fluid communication with the first storage. By virtue of a multi-part or multi-chamber storage configuration, it is for example possible to prevent or at least reduce, in an effective manner, a return flow of liquid into the separator space. By way of example, the second storage is connected to the first storage such that there exists only a single direction of flow for liquid, i.e. such that it is only possible for liquid to flow from the first storage into the second storage but not for liquid to flow from the second storage into the first storage. It is thereby possible for the amount of liquid residing within the first storage, which is connected via the at least one discharge opening to the separator space directly, to be kept low until the second storage becomes filled, whereby the risk of liquid flowing back into the separator space is also kept low.

In particular, the storage has associated with it a return flow preventing device which at least limits the return flow of fluid into the separator space. Such a return flow preventing device can be realized for example by a multi-chamber storage configuration.

In accordance with an embodiment of the invention, a cleaning device is provided which comprises a suction unit which has connected thereto a cyclone separator apparatus constructed in accordance with the invention.

The suction unit creates a suction flow via which suction fluid is capable of being sucked into the swirl chamber. The suction fluid is in particular dirt-laden suction air which may also contain cleaning liquid.

The cyclone separator apparatus constructed in accordance with the invention can be realized in a compact form so that the corresponding cleaning device can also be realized in a compact form.

The cleaning device constructed in accordance with the invention has the advantages that have already been described in the context of the suction unit constructed in accordance with the invention.

In particular, the cleaning device comprises a suction nozzle which is operatively connected for fluid communication with the at least one intake opening. This provides a way of suctioning dirt-laden suction fluid for cleaning a corresponding surface.

The cleaning device is configured as a suction device in particular, wherein said suction device may be configured as a wet suction device, a dry suction device or a wet/dry suction device.

It is also possible for the suction device to comprise at least one cleaning tool by which a surface that is to be cleaned is capable of being mechanically acted upon. By way of example, one or more lips for contact against a surface to be cleaned are provided as the cleaning tool, wherein by way of the one or more lips, liquid is capable of being “squeegeed off”. The cleaning tool may for example also be a sweeping tool or a scrubbing tool.

The cyclone separator apparatus constructed in accordance with the invention is advantageously used in a cleaning device and in particular in a suction device. The cleaning device is in particular a hand-carried cleaning device.

The following description of preferred embodiments serves in conjunction with the drawings to explain the invention in greater detail.

### BRIEF DESCRIPTION OF THE DRAWINGS

FIG. 1 is a perspective representation of a first exemplary embodiment of a cyclone separator apparatus constructed in accordance with the invention;

FIG. 2 is a further perspective view of the cyclone separator apparatus of FIG. 1, shown with storages removed;

FIG. 3 is a sectional view taken through the cyclone separator apparatus of FIG. 1;

FIG. 4 is a sectional view taken through line 4-4 of FIG. 3 (FIG. 3 is a sectional view taken through line 3-3 of FIG. 4);

FIG. 5 is the same view as FIG. 4, showing a first embodiment of a collar located at a dip tube;

FIG. 6 is the same view as FIG. 4, showing a second embodiment of a collar;

FIG. 7 is the same view as FIG. 4, showing a third embodiment of a collar;

FIG. 8 is a perspective representation of a second exemplary embodiment of a cyclone separator apparatus constructed in accordance with the invention;

FIG. 9 is a partial sectional view of the cyclone separator apparatus of FIG. 8;

FIG. 10 is a schematic sectional view of an exemplary embodiment of a cleaning device comprising a cyclone separator apparatus constructed in accordance with the invention;

FIG. 11 is a sectional view of a further exemplary embodiment of a cleaning device; and

FIG. 12 is a sectional view of a further exemplary embodiment of a cleaning device.

### DETAILED DESCRIPTION OF THE INVENTION

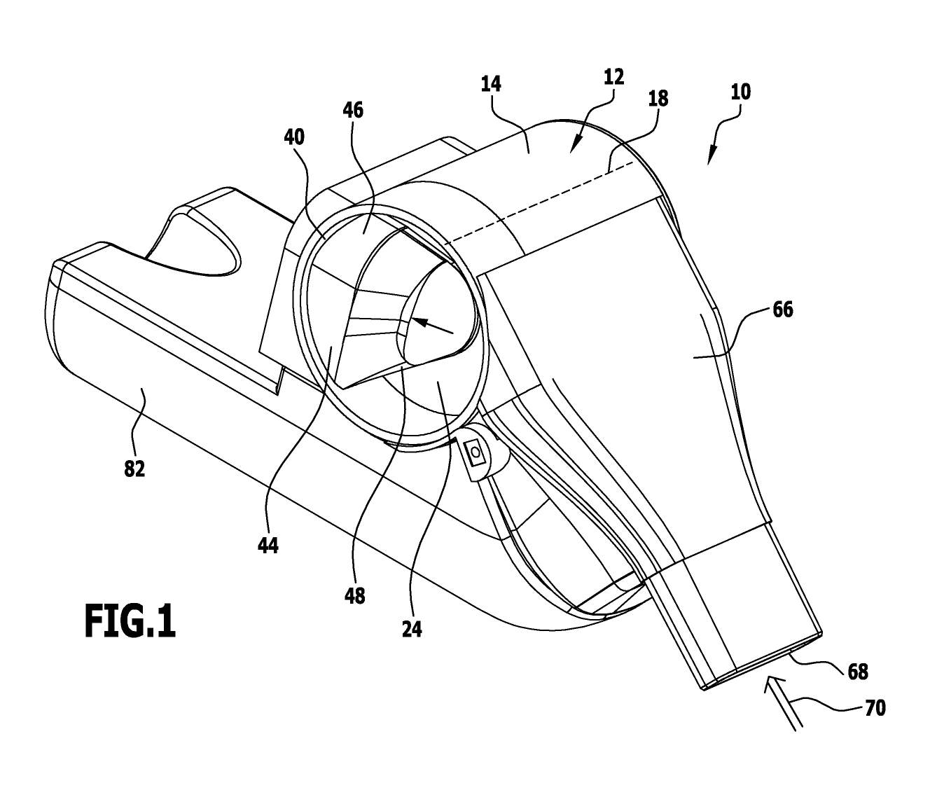

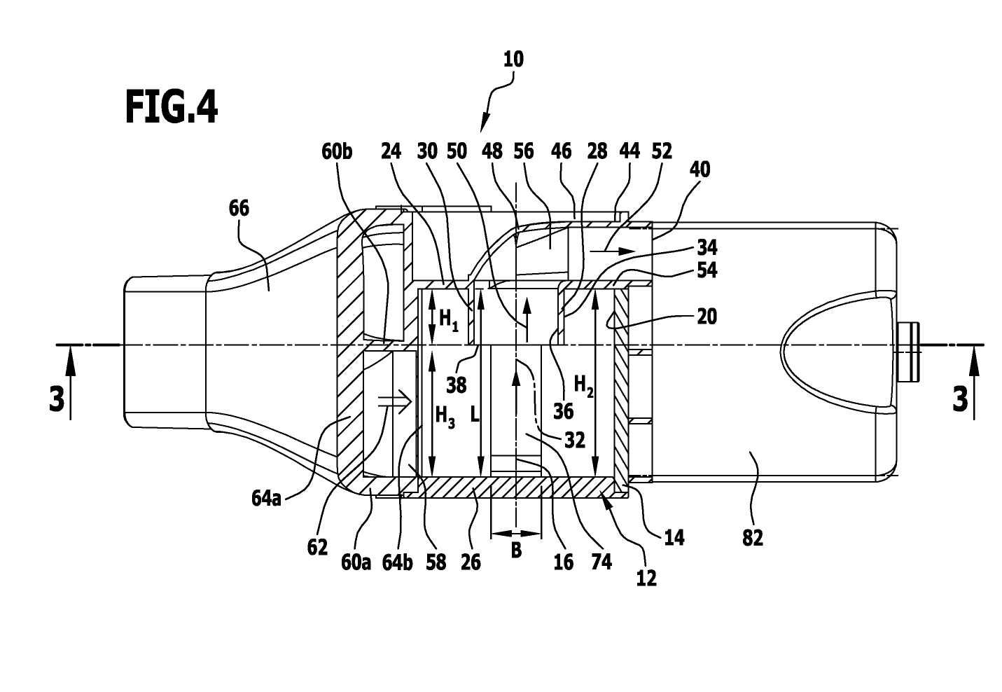

A first exemplary embodiment of a cyclone separator apparatus constructed in accordance with the invention, shown in FIGS. 1 to 7 and indicated therein by 10, comprises a swirl chamber (cyclone chamber) 12. The swirl chamber 12 comprises a shell wall 14. The shell wall 14 extends in an axial direction 16 (confer, for example, FIG. 4). The shell wall 14 has a (geometric) generatrix 18. An inner side 20 thereof is (geometrically) produced by the generatrix 18 revolving on a defined curve. This defined curve is in particular a circle. The shell wall 14 is then of a cylindrical configuration at least with respect to the inner side thereof.

In particular, the shell wall 14 has a rotationally symmetric shape with respect to an axial axis having the axial direction 16.

The shell wall 14 delimits an interior space which is a separator space 22. With a rotationally symmetric cylindrical shell wall 14, the separator space 22 has a hollow-cylindrical configuration.

In a direction transverse to the shell wall, the separator space 22 is closed by a first end wall 24 and an opposing, second end wall 26. The first end wall 24 and the second end wall 26 are connected to the shell wall 14 in fluid-tight relationship.

In an exemplary embodiment, the second end wall 26 is of a closed configuration, i.e. with no openings or the like; no fluid exchange can occur via the second end wall 26.

Arranged at the first end wall 24 is a dip tube 28. Said dip tube 28 comprises a cylindrical tube element 30. Said cylindrical tube element 30 is positioned inside the separator space 22. An axis 32 of the tube element 30 is coaxial with the axis of the shell wall 14.

In particular, the tube element 30 is of cylindrical configuration on an outer side 34 thereof and on an inner side 36 thereof.

The tube element 30 protrudes in a height H₁ in a direction parallel to the axial direction 16 into the separator space 22. Said height H₁ is less than a height H₂ of the separator space 22 between the first end wall 24 and the second end wall 26.

The dip tube 28 including the tube element 30 has a mouth 38 opening into the separator space 22.

The mouth 38 is in particular of a circular shape.

The dip tube 28 can be a separate element from the first end wall 24 which is for example affixed to the latter, or it can be formed in one piece with the first end wall 24.

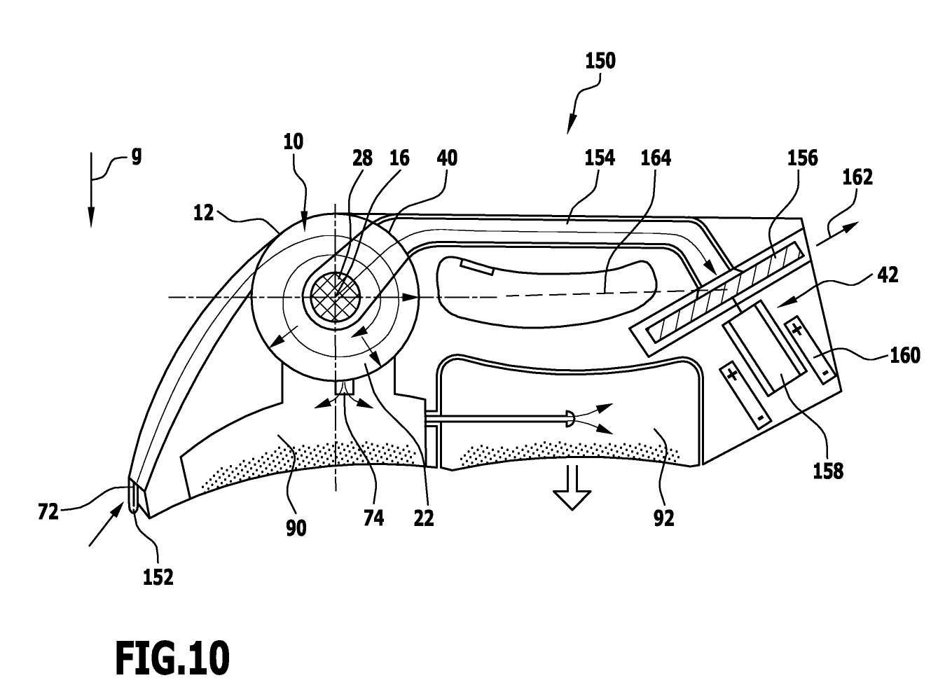

The dip tube 28 has a negative pressure application connection 40 associated with it, said negative pressure application connection 40 being connectable or connected to a suction unit 42 (confer FIG. 10). The separator space 22 can have a negative pressure applied thereto via the suction unit 42. Suction air can be removed from the separator space 22 via the negative pressure application connection 40.

In an exemplary embodiment, the dip tube 28 is connected to a pipe section 44 which is arranged exteriorly of the separator space 22. The pipe section 44 comprises a portion 46 which is arranged at least approximately parallel to the first end wall 24. It further comprises a portion 48 where the pipe section 44 has a bend. A change of flow direction can be induced in the portion 48.

Suction air that is ducted in the tube element 30 of the dip tube 28 has a principal flow direction 50 which is at least approximately parallel to the axial direction 16. A principal flow direction 52 in the pipe section 44 at the negative pressure application connection 40 is transverse and for example perpendicular to the principal flow direction 50. A directional change of flow takes place in the portion 48 (exteriorly of the separator space 22).

In an exemplary embodiment, a boundary wall 54 of the pipe section 44, and in particular in the portion 46 thereof, is formed by the first end wall 24. This makes for a compact construction.

The dip tube 28 has a mechanical filter 56 associated with it. This mechanical filter 56 is to prevent dirt particles and the like from passing to the suction unit 42. In particular, the mechanical filter 56 is arranged between the mouth 38 and the negative pressure application connection 40 at the cyclone separator apparatus 10.

In an exemplary embodiment, the mechanical filter 56 is arranged at the pipe section 44. By way of example, it is arranged directly above the tube element 30.

It is also possible, in principle, for the mechanical filter 56 to be arranged in a conduit running to the suction unit 42, said conduit being for example arranged downstream of the negative pressure application connection relative to the principal flow direction 52 of suction air.

The swirl chamber 12 has arranged thereat (at least) one intake opening 58 via which dirty fluid is sucked into the swirl chamber 12. The required negative pressure is generated via the suction unit 42, which provides the corresponding suction air.

The intake opening 58 is arranged at the shell wall 14. It has an extent that is parallel to the axial direction 16. In an exemplary embodiment, the intake opening is bounded by a first transverse wall 60a and by a second transverse wall 60b in spaced, opposing relationship to the first-named wall. The first transverse wall 60a and the second transverse wall 60b are in particular parallel to each other. It may be provided for the first transverse wall 60a to be aligned, with respect to an inner side thereof, with an inner side of the second end wall 26 (FIG. 4). Obstructions to the flow of dirty fluid into the swirl chamber 12 via the intake opening 58 are thereby prevented.

The second transverse wall 60b is located at least approximately at a level of the mouth 38 of the dip tube 28 in the separator space 22. The intake opening 58 then has a height H₃ parallel to the axial direction 16 which corresponds at least approximately to H₂-H₁.

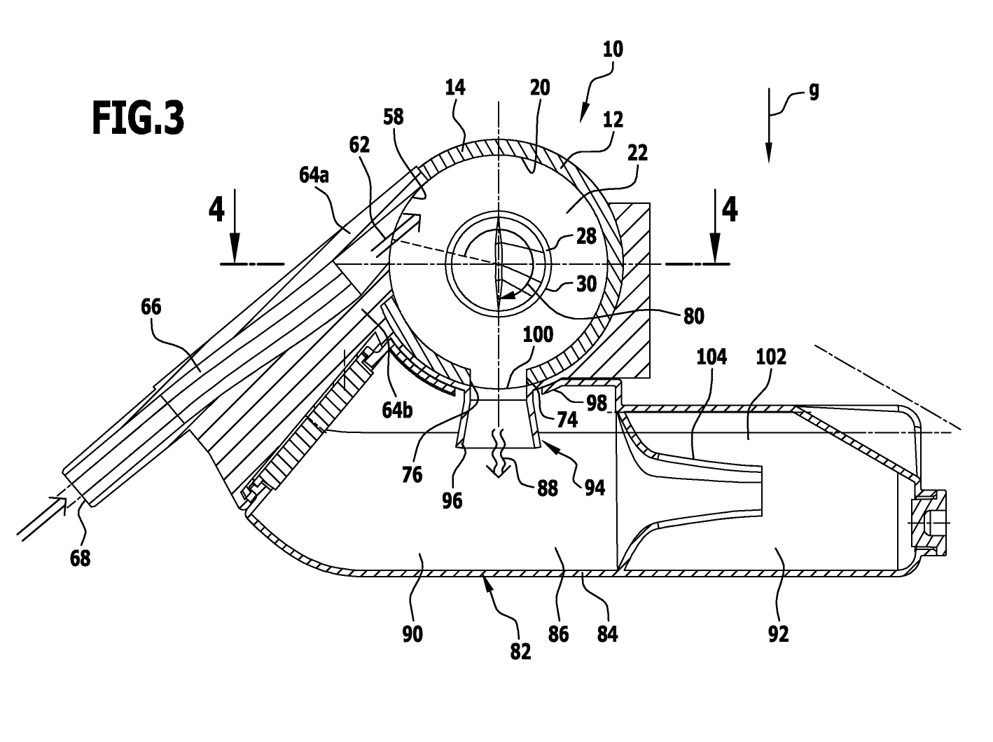

In an exemplary embodiment, the intake opening 58 is arranged such that dirty fluid flows into the swirl chamber 12 in a principal flow direction 62 (confer, for example, FIG. 3) which is at least approximately parallel to a tangent to the shell wall 14; dirty fluid then enters the separator space 22 tangentially via the intake opening 58.

Provision may be made for the intake opening 58 to be of a configuration or to have associated with it a corresponding device that provides for inflow to the separator space 22 in a way that establishes a spiral flow path.

An angular opening width of the intake opening 58 as an angular distance between opposing longitudinal walls 64a, 64b is typically in the range between for example 30° and 60° and is for example approximately 45°. The longitudinal walls 64a, 64b are transverse to the first transverse wall 60a and the second transverse wall 60b and are in each case connected thereto.

The longitudinal walls 64a and 64b are approximately parallel to the axial direction 16. An opening height as a distance between the first transverse wall 60a and the second transverse wall 60b of the intake opening 58 is usually larger than an opening width as a distance between the longitudinal walls 64a, 64b.

The intake opening 58 has an infeed element 66 associated with it. Said infeed element 66 comprises the transverse walls 60a, 60b and the longitudinal walls 64a, 64b. Via the infeed element 66, dirty fluid is coupled into the separator space 22 through the intake opening 58. The infeed element 66 is coupled in its geometrical shape to an application.

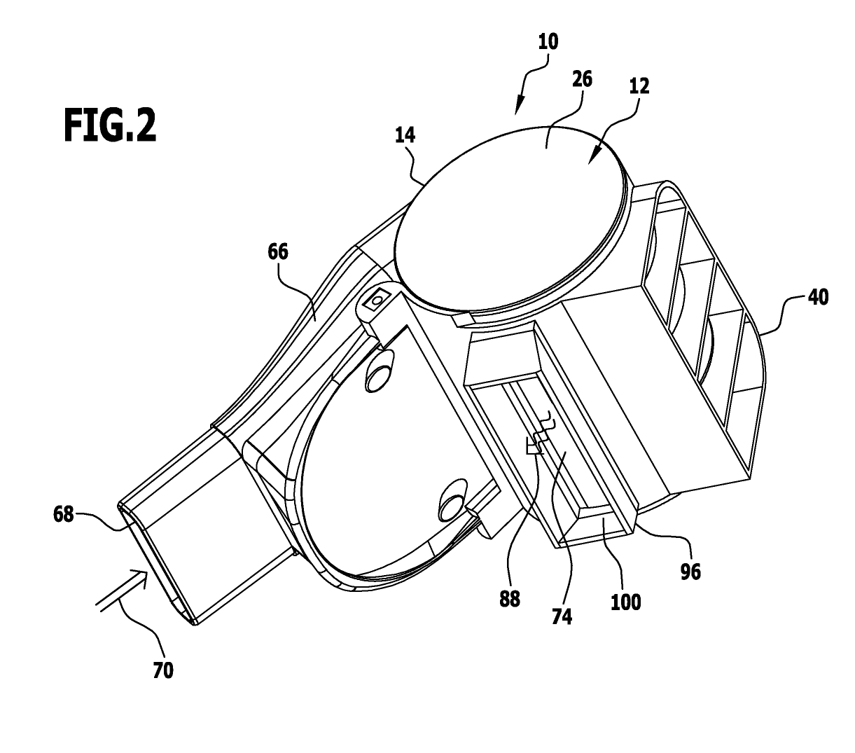

In the exemplary embodiment illustrated in FIGS. 1 and 2, the infeed element 66 has a connection 68 via which dirty fluid (indicated by the arrow 70 in FIG. 1) is capable of being coupled in. By way of example, the connection 68 is connected or capable of being connected to a suction nozzle 72 (FIG. 10).

Provision may be made for the infeed element 66 to vary in its width and for the infeed element 66 to have for example a larger width in the area of the intake opening 58 than in the area of the connection 68. By way of example, the infeed element 66 extends, in the direction of its height parallel to the axial direction 16, substantially over the entire height of the shell wall 14 in the area of the intake opening 58, whereas its corresponding height in the same direction is smaller in the area of the connection 68. As mentioned previously herein, height H₃ of the intake opening 58 can be smaller than the corresponding height (parallel to the axial direction 16) of the infeed element 66.

The infeed element 66 is fixed, relative to the shell wall 14, to the outer side of the shell wall 14 and is for example affixed to the shell wall directly or fixed relative thereto via a separate device.

In operation of the cyclone separator apparatus 10, separation of liquid and/or of dirt (wherein the liquid may also be dirt-laden), depending upon the particular application, takes place within the swirl chamber 12. The shell wall 14 has arranged thereat a discharge opening 74 for discharging the separated medium. The shell wall 14 has the discharge opening 74 formed therein in the form of a slot 76 which is continuous. By way of example, the slot 76 is rectangular in shape.

The discharge opening 74 extends in a direction of longitudinal extent 78. Said direction of longitudinal extent 78 is oriented parallel to the axial direction 16 or parallel to the generatrix 18 or parallel to the dip tube 28. The discharge opening 74 has a length L in the direction of longitudinal extent 78. The discharge opening 74 has a width B in a direction transverse to the direction of longitudinal extent 78.

Width B is smaller relative to length L; for example, it is at most 40% of length L.

In an exemplary embodiment, the width is in the range between 4 mm and 25 mm and is for example in the range between 5 mm and 20 mm. With this structure, typical contaminations that occur in practice can be discharged.

The discharge opening extends in the direction of longitudinal extent 78 substantially the entire height of the separator space 22. In particular, length L is at least 90% of height H₂ and for example corresponds to height H₂.

The discharge opening 74 is located at an angular distance from the intake opening 58. Said angular distance is in particular in the range between approximately 120° and 360°.

In the exemplary embodiment shown in FIG. 3, an angular distance 80 between the intake opening 58 (relative to a centre between the longitudinal walls 64a and 64b at the intake opening 58) and the discharge opening 74 is approximately 260°.

Here, a cyclonic direction (direction of rotation of the dirty fluid in the separator space 22) is in the same direction as the corresponding angle for the angular distance 80, i.e. in the exemplary embodiment of FIG. 3, the principal direction of rotation and the angle for the angular distance 80 are clockwise.

Provision is made for the axial axis of the swirl chamber 12 to be oriented at least approximately horizontally with respect to the direction of gravity g when the corresponding cleaning device is employed in its intended use; this will be discussed in more detail below. In intended use, the discharge opening 74 is located below the intake opening 58 with respect to the direction of gravity g. In particular, in intended use, the discharge opening 74 is located at or near a point of the corresponding cleaning device which is lowermost with respect to the direction of gravity g.

The swirl chamber 12 has associated with it a storage device 82 which receives separated medium separated by the swirl chamber 12.

The storage device 82 comprises a storage chamber 84 having a receiving space 86. The discharge opening 74 leads into the receiving space 86 so that separated medium 88 from the separator space 22, passing through the discharge opening 74, can enter the receiving space 86.

In the exemplary embodiment shown, the storage device is of multi-chamber configuration, including a first storage 90 and a second storage 92. The first storage 90 is formed by the storage chamber 84.

The first storage 90 has associated with it a return flow preventing device 94, the function of which is to prevent or at least reduce return flow of separated medium from the first storage 90 back into the separator space 22.

In an exemplary embodiment, the return flow preventing device 94 is configured in the form of a slosh guard device. This comprises for example a collar 96 which is arranged at the storage chamber 84, in particular at a lid wall 98 thereof. Formed in the collar 96 is an opening 100 which corresponds to the discharge opening 74 in the shell wall 14. The collar 96 protrudes into the receiving space 86 of the storage device 82.

The second storage 92, which has a receiving space 102, is arranged downstream of the first storage 90. Separated medium can be routed from the first storage 90 into the second storage 92 via a connecting device 104.

By way of example, it is possible for liquid (which may also be laden with dirt) to flow from the first storage 90 into the second storage 92, wherein the connecting device 104 comprises a directional valve so that there is no chance for liquid from the receiving space 102 to flow back into the receiving space 86.

It is thereby possible for the amount of liquid resident in the receiving space 86, which is directly adjacent to the separator space 22, wherein separated medium flows from the separator space 22 into the receiving space 86 directly, to be kept relatively low during operation so that sloshing back of liquid into the separator space 22 is prevented or at least reduced because the amount of liquid contained in the receiving space 86 is kept low compared with the case where the storage device 82 comprises only one single receiving space which adjoins the discharge opening 74 directly.

In the present exemplary embodiment, the connecting device 104 then forms, in particular in conjunction with a corresponding valve or by itself, a part of the return flow preventing device 94.

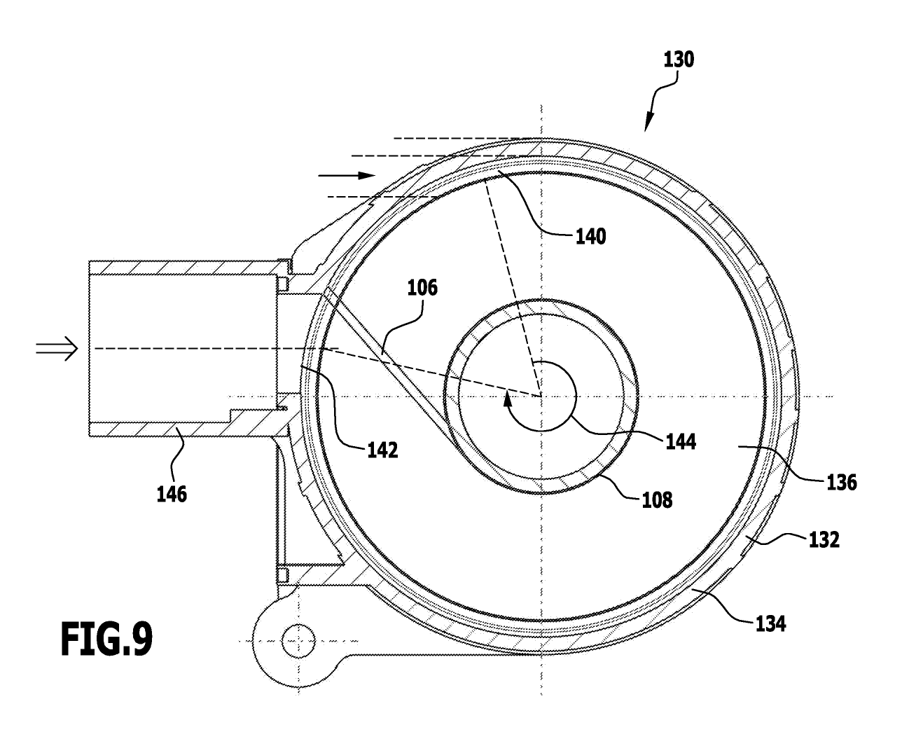

The separator space 22 can have arranged therein one or more guide elements of a guide device 106 (confer FIG. 9) which predetermine a direction for the flow in the separator space 22.

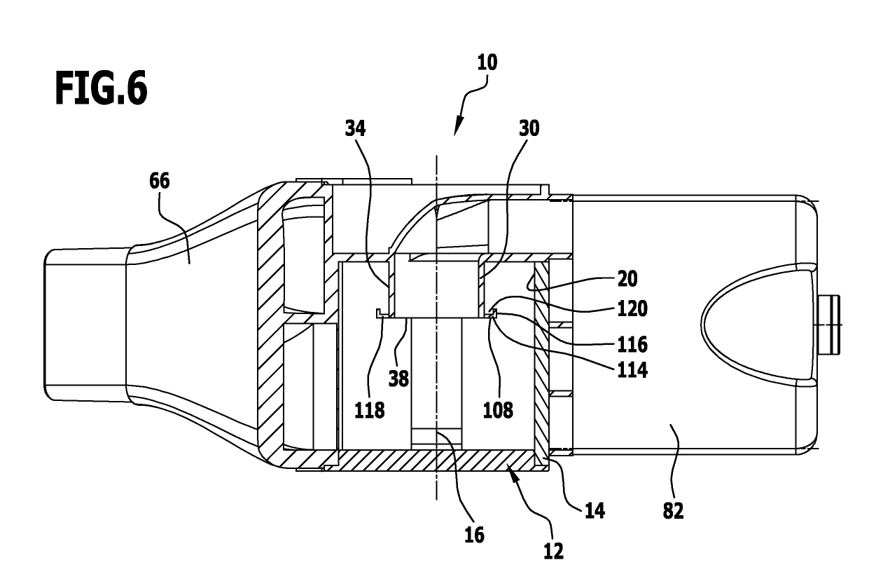

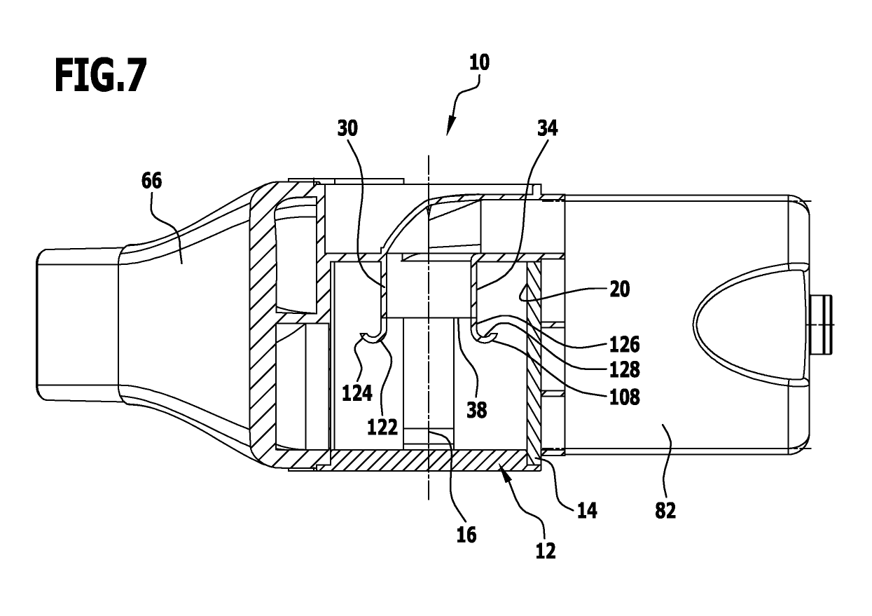

In an exemplary embodiment (FIGS. 6 and 7), the tube element 30 of the dip tube 28 has arranged, at the mouth 38 thereof, a collar 108 within the separator space 22. In particular, by way of the collar 108, which faces away from the dip tube 28, the ingress of liquid from the separator space 22 into the dip tube 28 is prevented or at least reduced. By way of the collar 108, an effective opening width is enlarged, relative to the mouth 38 with maximum outer diameter d, to maximum diameter D which is greater than d.

Via the collar 108, there is formed at the dip tube 28, with the outer side 34 thereof, a kind of channel or trough 110 within the separator space 22, said trough 110 encircling the dip tube 28.

At its maximum diameter, the collar 108 has a distance from the inner side 20 of the shell wall 14 that is less than that of the dip tube 28.

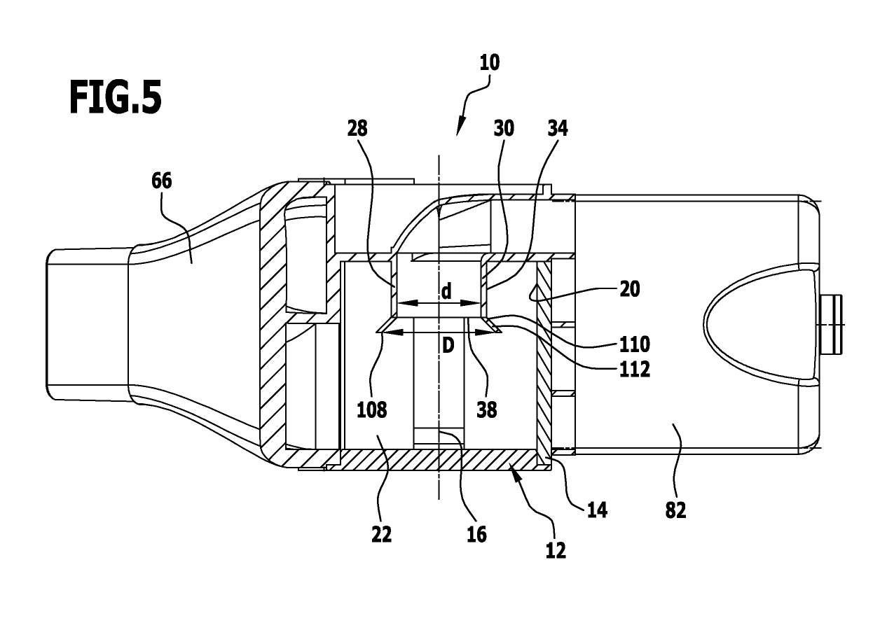

In an exemplary embodiment (FIG. 5), the collar 108 is configured as a funnel 112 of frustoconical shape, wherein the side having the smaller diameter is located at the mouth 38 of the cylindrical dip tube 28 and the side having the larger opening width is spaced from the mouth 38.

In a variant (FIG. 6), the collar 108 is formed by an annular element 114 which is located in the area of the mouth 38, at the exterior of the tube element 30, and comprises a raised rim 116. The raised rim is transverse and in particular perpendicular to an annular disk 118. An annular channel 120 is formed between the raised rim 116, the annular disk 118 and the outer side 34 of the dip tube 28.

In a further variant (FIG. 7) of a collar 108, said collar 108 is formed by an annular element 122 which likewise has a raised rim 124. By way of the raised rim, the annular element 122 has formed thereat a channel 128 around an (imaginary) extension 126 of the cylindrical outer side of the dip tube 28.

The collar 108, including the exemplary embodiments 112, 114, 122 thereof, prevents the ingress of liquid into the dip tube 28 or reduces the amount of liquid ingress.

The cyclone separator apparatus 10 works as follows:

In operation, the suction unit 42 applies a negative pressure via the negative pressure application connection 40. A suction flow is created which is coupled into the separator space 22 via the dip tube 28.

By way of said suction flow, dirty fluid can be sucked in through the connection 68. Said dirty fluid enters the separator space 22 tangentially or spirally. A cyclonic flow develops and vortex separation occurs. Liquid or dirt particles or dirt-laden liquid is or are separated. The separated medium is discharged through the discharge opening 74 into the storage device 82.

“Clean” suction air is “exhausted” through the pipe section 44. The mechanical filter 56, which is in particular a fine filter, ensures that the discharged suction air carries as low a dirt load as possible.

The cyclone separator apparatus 10 comprising the swirl chamber 12 can be realized in a compact form.

In operation, separated medium is removed “fast” from the separator space 22 through the discharge opening 74 in the form of the slot 76 in the shell wall 14 and the accumulation of separated medium in the separator space 22 is reduced. The swirl chamber 12 comprising the shell wall 14 can be formed in a relatively simple and in particular cylindrical manner. The need for providing a cone or taper is eliminated.

In its function, the cyclone separator apparatus 10 is insensitive to inclination, in particular when the axial axis 16 is oriented at least approximately horizontally with respect to the direction of gravity g; the discharge opening 74 need not lie on a vertical axis with respect to the direction of gravity g but may be inclined relative thereto.

As a result, the cyclone separator apparatus 10 constructed in accordance with the invention is particularly advantageous for use in hand devices where fluctuations in inclination may occur because of their hand-guided nature.

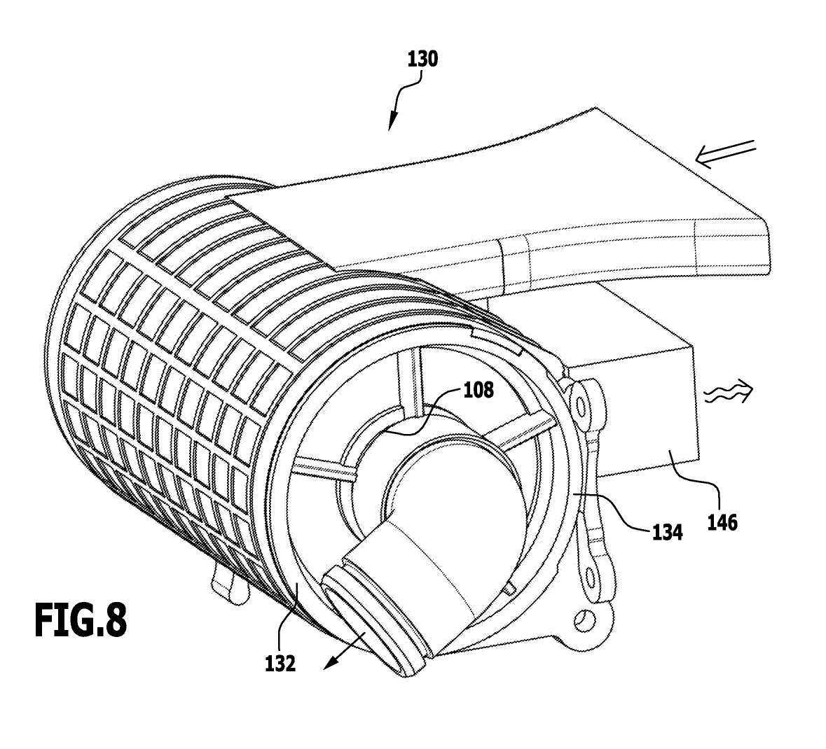

A second exemplary embodiment of a cyclone separator apparatus constructed in accordance with the invention, shown in FIGS. 8 and 9 and indicated therein by 130, is in principle of identical construction as the cyclone separator apparatus 10. A swirl chamber 132 comprising a cylindrical shell wall 134 is provided. The shell wall 134 surrounds a separator space 136. Opening into the separator space 136 is a dip tube 138 which is connectable or connected to a suction unit 42.

The shell wall 134 has arranged thereat an intake opening 140. Furthermore, the shell wall has arranged thereat a discharge opening 142.

In the exemplary embodiment shown, an angular distance 144 to the intake opening 140, which in particular enables tangential and/or spiral inflow, amounts to approximately 300°.

As mentioned above, a guide device 106 having one or more guide elements is provided in order to predetermine a defined direction of flow.

The discharge opening 142 has a storage device 146 connected thereto.

Otherwise, the cyclone separator apparatus 130 works in the same way as the cyclone separator apparatus 10.

An exemplary embodiment of a cleaning device, shown in FIG. 10 and designated 150 therein, is a hand suction device. Said hand suction device has a suction nozzle 72 as mentioned above.

The suction nozzle can have associated with it a cleaning tool for mechanical action on a surface that is to be cleaned.

By way of example, said cleaning tool is configured as a lip 152 for squeegeeing off liquid.

By way of example, the cleaning device 150 has the cyclone separator apparatus 10 integrated therein. In intended use, the axial direction 16 is an at least approximately horizontal direction relative to the direction of gravity g. The suction nozzle 72 and the lip 152 are then arranged such that surface contact is enabled in intended use in the at least approximately horizontal orientation.

In the cleaning device 150, the suction unit 42 is arranged in spaced relation to the swirl chamber 12. A conduit 154 is arranged between the negative pressure application connection 40 and the suction unit 42, said conduit 154 being for example formed by a tube. The conduit 154 can be connected directly to the negative pressure application connection 40 or the latter can be formed on the conduit 154.

The suction unit 42 comprises a suction fan 156 in which one or more impellers are driven by a fan motor 158. The fan motor 158 is for example an electric motor which can have associated with it a battery device 160, in particular one which uses rechargeable batteries.

Exhaust air 162 from the suction fan 156 is discharged to the exterior.

The suction unit 42 generates the negative pressure required, which provides the suction flow that is “coupled into” the separator space 22 via the corresponding dip tube 28. Dirty fluid that is present at the suction nozzle 72 is sucked into the separator space 22. Cyclonic flow develops in the separator space 22, and separated medium is discharged through the discharge opening 74.

The cleaning device 150 has a direction of longitudinal extent 164, and the axial axis 16 is transverse and in particular perpendicular to said direction of longitudinal extent 164.

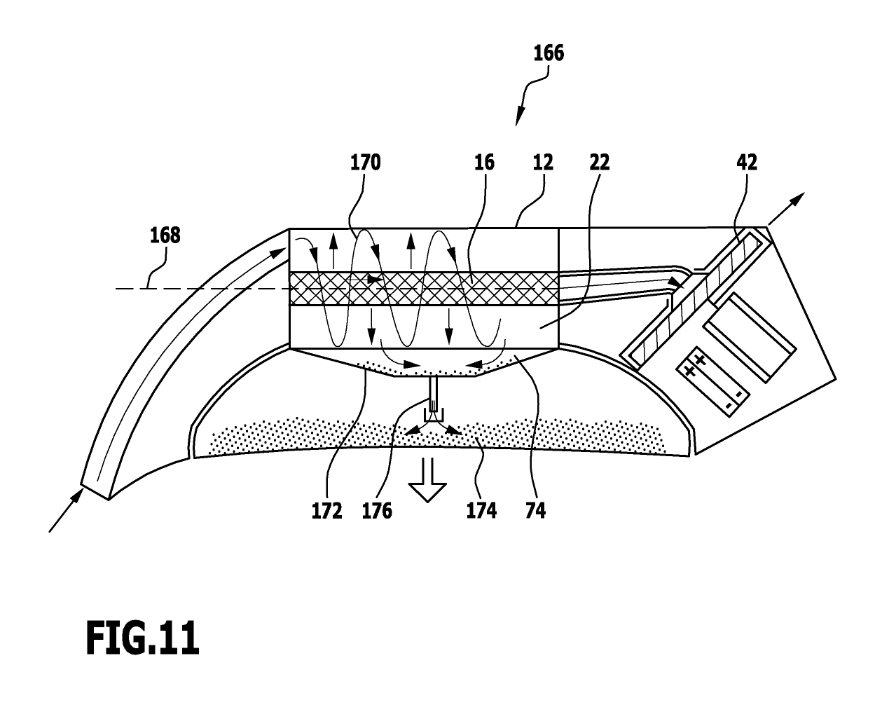

In an exemplary embodiment of a cleaning device 166 (FIG. 11), said cleaning device 166 has a direction of longitudinal extent 168. The corresponding swirl chamber 12 of the cyclone separator apparatus 10 is installed in such a way that the horizontal axis 16 is at least approximately parallel to the direction of longitudinal extent 168.

In FIG. 11, a cyclonic flow is indicated by the reference character 170.

Separated medium is discharged via the discharge opening 74. The discharge opening 74 extends substantially the entire height H₂ of the separator space 22.

In the cleaning device 166, a discharge channel 172 is arranged at the discharge opening 74. By way of example, the discharge channel 172 has a cross-section tapering towards a storage 174. The storage 174 is, for example, removably arranged on the cleaning device 166. The discharge channel 172 forms a kind of collection space via which separated medium is capable of being discharged into the storage 174 via a corresponding connecting device 176.

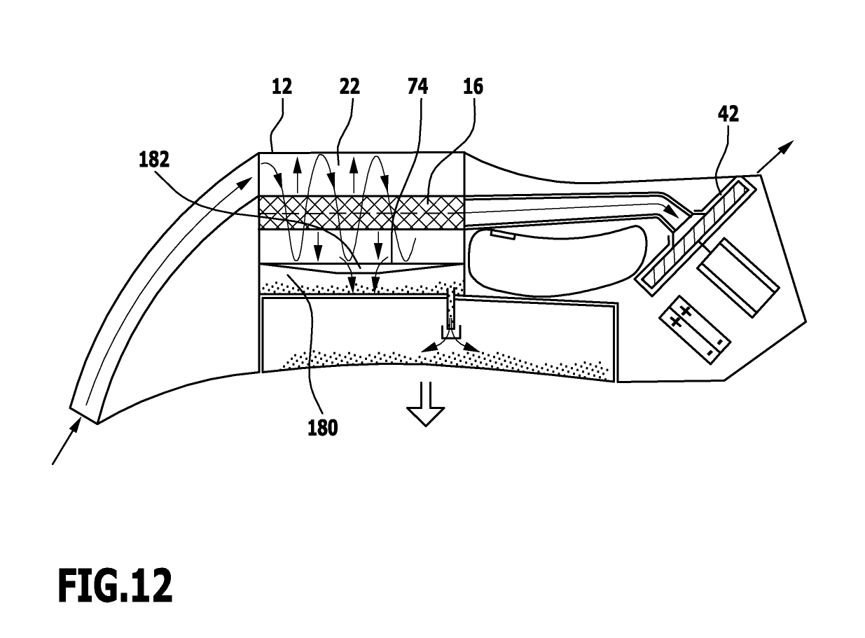

In an exemplary embodiment of a cleaning device which is shown in FIG. 12, is indicated therein at 178 and is a variant of the cleaning device 166, the discharge opening 74 has associated with it a first storage 180, wherein a discharge channel 182 can be arranged between the first storage 180 and the discharge opening 74. Downstream of the first storage 180 is a second storage 184, in particular wherein liquid from the first storage 180 can pass into the second storage 184.

In intended use, the storage device 82 comprising the receiving space(s) 86 and 102 is preferably arranged below the discharge opening 74 with respect to the direction of gravity g. In the cleaning devices 166 and 178, separated medium can then flow by gravity from the discharge channel 172 into the storage 174 or from the discharge channel 182 into the first storage 180 and from thence into the second storage 184, respectively.

In principle, the cyclone separator apparatuses 10 and 130 are suitable for use in conjunction with any suction cleaning device for dry suction or wet suction. In dry suction, the suctioned fluid is a “dry fluid” composed of air and particles of dirt. In wet suction, the dirty fluid is an air/liquid/particulate matter mixture.

The suction cleaning device may comprise a cleaning liquid application device for the surface that is to be cleaned or it may be configured without such a cleaning liquid application device.

The cyclone separator apparatus can be realized in a compact form so that it may be advantageously used in hand-guided devices and in particular in hand devices or stick-type devices or rollable, canister-type devices.

### REFERENCE SYMBOL LIST

10 cyclone separator apparatus (first exemplary embodiment)
12 swirl chamber
14 shell wall
16 axial direction
18 generatrix
20 inner side
22 separator space
24 first end wall
26 second end wall
28 dip tube
30 tube element
32 axis
34 outer side
36 inner side
38 mouth
40 negative pressure application connection
42 suction unit
44 pipe section
46 portion
48 portion
50 principal direction of flow
52 principal direction of flow
54 boundary wall
56 mechanical filter
58 intake opening
60a first transverse wall
60b second transverse wall
62 principal direction of flow
64a longitudinal wall
64b longitudinal wall
66 infeed element
68 connection
70 dirty fluid
72 suction nozzle
74 discharge opening
76 slot
78 direction of longitudinal extent
80 angular distance
82 storage device
84 storage chamber
86 receiving space
88 separated medium
90 first storage
92 second storage
94 return flow preventing device
96 collar
98 lid wall
100 opening
102 receiving space
104 connecting device
106 guide device
108 collar
110 channel
112 funnel
114 annular element
116 raised rim
118 annular disk
120 channel
122 annular element
124 raised rim
126 extension
128 channel
130 cyclone separator apparatus (second exemplary embodiment)
132 swirl chamber
134 shell wall
136 separator space
138 dip tube
140 intake opening
142 discharge opening
144 angular distance
146 storage device
150 cleaning device
152 lip
154 conduit
156 suction fan
158 fan motor
160 battery device
162 exhaust air
164 direction of longitudinal extent
166 cleaning device
168 direction of longitudinal extent
170 cyclonic flow
172 discharge channel
174 storage
176 connecting device
178 cleaning device
180 first storage
182 discharge channel
184 second storage

1. A cyclone separator apparatus for a cleaning device, comprising:
a swirl chamber having a shell wall which delimits a separator space;
a dip tube extending into the separator space of the swirl chamber;
a negative pressure application connection which is arranged at the dip tube or is operatively connected for fluid communication therewith and is connectable or connected to a suction unit;
at least one intake opening which is arranged at the swirl chamber; and
at least one discharge opening which is arranged at the swirl chamber;
wherein the at least one discharge opening is configured in the form of a slot in the shell wall.

2. The cyclone separator apparatus in accordance with claim 1, wherein the at least one discharge opening is, in a direction of longitudinal extent, at least one of (i) oriented at least approximately parallel to the dip tube, (ii) oriented at least approximately parallel to a generatrix of the shell wall and (iii) oriented at least approximately parallel to an axial direction of the swirl chamber.

3. The cyclone separator apparatus in accordance with claim 1, wherein the at least one discharge opening has a length in a direction of longitudinal extent and has a width in a direction transverse to the direction of longitudinal extent, wherein the width is less than the length.

4. The cyclone separator apparatus in accordance with claim 3, wherein the width is constant over the direction of longitudinal extent.

5. The cyclone separator apparatus in accordance with claim 3, wherein the width is no more than 40% of the length.

6. The cyclone separator apparatus in accordance with claim 3, wherein the width is at least one of (i) at least 4 mm and (ii) at most 25 mm.

7. The cyclone separator apparatus in accordance with claim 1, wherein the shell wall has arranged thereat a single discharge opening.

8. The cyclone separator apparatus in accordance with claim 1, wherein the separator space has an inside length in an axial direction and wherein the at least one discharge opening extends over at least 90% of the inside length.

9. The cyclone separator apparatus in accordance with claim 1, wherein the separator space has a constant cross-section along an axial direction.

10. The cyclone separator apparatus in accordance with claim 1, wherein the shell wall is of cylindrical configuration.

11. The cyclone separator apparatus in accordance with claim 1, wherein the dip tube is of cylindrical configuration relative to at least one of an outer side and an inner side thereof.

12. The cyclone separator apparatus in accordance with claim 1, wherein an angle between the at least one intake opening and the at least one discharge opening is in the range between 120° and 360° relative to a flow direction of fluid at the intake opening.

13. The cyclone separator apparatus in accordance with claim 1, wherein in intended use of the cleaning device, the at least one discharge opening is located below the at least one intake opening with respect to the direction of gravity.

14. The cyclone separator apparatus in accordance with claim 1, wherein in intended use of the cleaning device, an axial direction of the swirl chamber is oriented at least approximately horizontally with respect to the direction of gravity.

15. The cyclone separator apparatus in accordance with claim 1, wherein the at least one intake opening is arranged at the swirl chamber such that flow entering thereinto develops in a path that is at least approximately parallel to a tangent to the shell wall.

16. The cyclone separator apparatus in accordance with claim 1, wherein the dip tube is arranged at a first end wall of the swirl chamber which is oriented transversely to the shell wall and delimits the separator space.

17. The cyclone separator apparatus in accordance with claim 15, wherein a second end wall of the swirl chamber which is located opposite the first end wall and delimits the separator space is configured in a manner that is free of openings.

18. The cyclone separator apparatus in accordance with claim 1, wherein the at least one discharge opening is oriented at least approximately parallel to a principal flow direction of suction air inside the dip tube.

19. The cyclone separator apparatus in accordance with claim 1, wherein at least one of the dip tube and a conduit from the dip tube to the suction unit have a mechanical filter associated therewith.

20. The cyclone separator apparatus in accordance with claim 1, wherein a collar is arranged at a mouth of the dip tube in the separator space, said collar having an extent transverse to the dip tube and facing away from the dip tube.

21. The cyclone separator apparatus in accordance with claim 20, wherein the collar comprises one or more elements that project transversely from the dip tube.

22. The cyclone separator apparatus in accordance with claim 20, wherein the collar has a larger maximum outer diameter than that of the mouth of the dip tube.

23. The cyclone separator apparatus in accordance with claim 20, wherein the collar is configured as a frustoconical element.

24. The cyclone separator apparatus in accordance with claim 20, wherein the collar has a raised rim.

25. The cyclone separator apparatus in accordance with claim 1, wherein the separator space has arranged therein a guide device for the flow which predetermines a direction for the flow inside the separator space.

26. The cyclone separator apparatus in accordance with claim 1, wherein the at least one discharge opening leads into a storage for separated medium.

27. The cyclone separator apparatus in accordance with claim 26, wherein the storage is a first storage which is located upstream of a second storage, wherein the second storage is operatively connected for fluid communication with the first storage.

28. The cyclone separator apparatus in accordance with claim 26, wherein the storage has associated with it a return flow preventing device which at least limits the return flow of fluid into the separator space.

29. A cleaning device, comprising a suction unit which has connected thereto a cyclone separator apparatus comprising:
a swirl chamber having a shell wall which delimits a separator space;
a dip tube extending into the separator space of the swirl chamber;
a negative pressure application connection which is arranged at the dip tube or is operatively connected for fluid communication therewith and is connectable or connected to a suction unit;
at least one intake opening which is arranged at the swirl chamber; and
at least one discharge opening which is arranged at the swirl chamber;
wherein the at least one discharge opening is configured in the form of a slot in the shell wall.

30. The cleaning device in accordance with claim 29, wherein a suction nozzle is provided which is operatively connected for fluid communication with the at least one intake opening.

31. The cleaning device in accordance with claim 29, wherein the cleaning device is configured as a suction device.

32. The cleaning device in accordance with claim 31, wherein at least one cleaning tool is provided by which a surface that is to be cleaned is capable of being mechanically acted upon.
